(19) United States
(12) Patent Application Publication
(10) Pub. No.: US 2021/0142408 A1
(43) Pub. Date: May 13, 2021

(54) METHOD AND SYSTEM FOR MANAGING AND PROCESSING FOREIGN CURRENCY CARD PAYMENT TRANSACTIONS

(71) Applicant: FXConcierge Limited IoM, Douglas (GB)

(72) Inventor: Christopher Compston, Douglas (GB)

(73) Assignee: FXConcierge Limited IoM, Douglas (GB)

(21) Appl. No.: 17/096,696

(22) Filed: Nov. 12, 2020

Related U.S. Application Data
(60) Provisional application No. 62/934,372, filed on Nov. 12, 2019.

(51) Int. Cl. G06Q 40/04; G06Q 20/06; G06Q 20/34; G06Q 20/08; G06Q 20/38; G06Q 40/02; G06F 16/955

(52) U.S. Cl. CPC G06Q 40/04; G06Q 20/0655; G06Q 20/34; G06Q 20/085; G06F 3/0482; G06Q 40/02; G06F 16/955; G06Q 2220/00; G06Q 20/381

(57) ABSTRACT

A computer system and method for processing payments between a merchant and customer for goods/services using a payment processing system, including determining if a native currency of the merchant matches with a native currency of the customer. The price of the merchants' goods/services is then determined using the payment processing, in the native currency of the customer if no match was determined between the native currency of the merchant and the native currency of the customer. The customer is then enabled to purchase the merchants' goods/services, by a payment acquirer associated with the merchant, using the customer's native currency whereby the price displayed to the customer is the actual price paid by the customer for the merchants' goods/services. A settlement amount is transmitted for the price of the purchased goods/services from the payment processing system to the payment acquirer in the native currency denomination of the merchant, and transmitted from the payment acquirer to the payment processing system is the customer payment for the purchased goods/services, in the native currency denomination of the customer. The payment acquirer then transmits to a bank account designated by the merchant, the received settlement amount in the native currency denomination of the merchant.

### CROSS REFERENCE TO RELATED APPLICATIONS

This application claims priority to U.S. Patent Application Ser. No. 62/934,372 filed Nov. 12, 2019 which is incorporated herein by reference in its entirety.

### FIELD OF THE INVENTION

The disclosed embodiments generally relates to data processing systems for foreign card payments, and in particular relates to transactions in which a foreign exchange transaction is required to settle payment for goods or services. The invention finds particular application in relation to large numbers of low value foreign currency card transactions.

### BACKGROUND OF THE INVENTION

Internet electronic commerce developments provide the need for foreign exchange transactions typically involving small sums for a number of markets, including online retail markets. Websites provide an opportunity for worldwide marketing of products. These may be selected and purchased online, often from a retailer or other business based in a different country to the customer or working in a different currency to that of a card holding customer. In retail transactions purchasing is often carried out by means of a credit or debit card transaction. The customer sees a price for a product on a e-commerce website expressed in a foreign currency, and the customer purchases the goods by providing their card details to the website. As result the card issuer and the merchant acquirer are required to undertake a multi-currency, foreign exchange transaction as part of the purchase, in order to calculate the sum owed by the customer to the merchant in the customer's domestic currency for the foreign currency purchase. This domestic currency amount is then applied to the customer's card account by the card issuing financial institution.

It is to be appreciated that throughout such foreign currency card transactions the customer often does not actually know what the charge in their domestic currency will be at the time of purchase. The customer typically waits until it appears on their card statement. Naturally the customer could estimate what the exchange rate applied may be; for example with reference to published tourist rates, or on the basis of past experience, but due to the number of entities involved in such multi-currency, foreign exchange transactions, it is not straight forward to determine the relevant foreign currency exchange rate and when it will be applied by the relevant institution.

It is noted the foreign exchange transaction generates a significant income stream for the scheme member executing the foreign exchange transaction. This is because the scheme member often applies a retail foreign exchange rate to the customer's transaction, but can itself rely upon a wholesale foreign exchange rate which the scheme member obtains in processing a transaction.

It is also noted that many card issuers charge an additional fee for “non-domestic transactions”, which can significantly increase the cost to the customer, when undertaking a card transaction that involves a non-domestic or foreign currency.

The scheme member, but not the customer, may be able to take advantage of the wholesale foreign exchange markets by agglomerating a plurality of individual foreign exchange transactions of the type described above into a wholesale transaction. The effect to the scheme member may be a further profit arising from the difference between the retail foreign exchange rate offered to the customer and the wholesale rate available to the bank. In the case of a card transaction this is in addition to the profit generated by the offering of credit to the customer in the normal manner of a credit card or by the offering of overdraft services in relation to the use of a debit card. It is further noted that trans-border transactions are not limited to retail credit and debit card payments. Other payment methods may be used, such as direct currency transfer from one bank account to another foreign currency bank account. Typically, however, a foreign exchange transaction is conducted in the home country of the customer and the payment is transferred in the appropriate foreign currency. A problem with this mechanism is that where a transaction involves relatively low value payments, the customer will not be able to access wholesale foreign exchange rates, which will usually only be available on very large value transactions. Hence, low value foreign exchange and card transactions are typically inefficient, and act as a constraint to cross border trade. This is particularly true of the Internet market, which provides a ready mechanism for cross border transactions such as retail sales, foreign share dealing, fund transfers etc.

Current transaction processes prejudice the payee by transferring the foreign exchange cost burden to the payee. In the example of a card purchase, the card holding customer often obtains a relatively unfavorable exchange rate, and may not know the actual foreign exchange rate which will be applied, and therefore the actual cost of the goods or service the customer purchases until the transaction appears on their card statement of account. The customer could contact their bank to ask for the instantaneous exchange rate, but this requires the customer to go to the effort of making contact, and in addition conducting a calculation to obtain the actual cost. Also, this process may not be accurate as the foreign exchange element of a foreign currency card transaction may not settle for days after the customer's actual commercial transaction. For low value transactions the consumer is most unlikely to bother, and typically accepts the prejudice of not knowing or viewing the actual cost.

It is to be further appreciated that cross-border payments involving foreign exchange are often made by credit or debit card. In effecting any card payment there are two distinct elements to a payment; issue and acquisition. The card industry is divided along two distinct lines. These are card issuing and card acquiring. Cards are available under different “schemes”, such as Visa, Mastercard, American Express. Each of these schemes imposes rules which ensure the acceptability of the cards by all parties. Card issuing is undertaken by a wide range of banks and non-bank financial entities. The card issuers issue cards to cardholders and have responsibility for providing credit, payment and accounting services. For example, Citibank issues cards under the Mastercard scheme.

Merchant acquirers often provide the merchants who sell products and services with the infrastructure for accepting card-based payments. Merchant acquisition is a highly commoditized business that is dominated by a small number of global providers. For example Worldpay is one of the largest multi-currency global merchant acquirers. It has the capability to accept card transactions in many foreign currencies for settlement in about 25 different currencies according to the needs of individual merchants. Currently the management of foreign exchange currency exposure by the merchant acquirers is based upon foreign currency exchange rates quoted by the various card schemes through which settlement is managed. This has in the past not been too much of a problem to the merchant acquirers as the margins applied to the transactions are high and capable of absorbing fluctuations in the foreign exchange rate over time. However, as the volume of transactions has increased the benefits of a more efficient system have become apparent.

Merchants that undertake multi-currency e-commerce transaction, may be offered the option of either a multi-currency or Dynamic Currency Conversion solution offered by their payment acquirer. Thus, an additional merchant service charge is normally added for foreign currency card transactions. The extra foreign currency processing fees or charges cover the perceived higher risk of transacting internationally and the higher charges passed onto the payment acquirer by the card schemes and by the payment acquirer to international trading merchants. These extra costs mean that online merchants are often paying much more to access international customers.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a data processing system capable of managing low value foreign exchange card transactions in a manner which improves efficiency, so that transactions may be conducted at lower costs per transaction and so that international shoppers have the option to enter into international e-commerce transactions in their local currency irrespective of the merchant's trading currency is described.

In accordance with one or more illustrated embodiments, a standalone, multi-currency payment solution module (hereinafter referred to as the “FXC Module”) is described for an online merchant. For instance, for a fee per transaction price (e.g., 1%), the FXC Module provides cost effective solution configured for utilization by online merchants for processing their international foreign currency online card payments, in conjunction with a designated payment acquirer partner of the FXC Module. In a preferred embodiment, the FXC Module preferably has minimal, or no set up costs, is simple to deploy, and provides cost savings when compared to the aforesaid traditional multi-currency payment solutions. A simple merchant account fee structure (e.g., 1%) facilitates accounting ease while providing an intuitive user interface (“UI”) enabling rapid reconciliation of sales while also enabling the ability to quickly assess the impact of new markets. The FXC Module is configured to calculate and display prices (for goods and/or services) in the card holding customer's preferred currency or home currency and is configurable for integration into an online store, preferably via an Application Program Interface (“API”).

In another embodiment provided is a computer system and method for processing payments between a merchant and customer for goods/services using a payment processing system, including determining if a native currency of the merchant matches with a native currency of the customer. The price of the merchants' goods/services is then determined using the payment processing, in the native currency of the customer if no match was determined between the native currency of the merchant and the native currency of the customer. The customer is then enabled to purchase the merchants' goods/services, by a payment acquirer associated with the merchant, using the customer's native currency whereby the price displayed to the customer is the actual price paid by the customer for the merchants' goods/services. A settlement amount is transmitted for the price of the purchased goods/services from the payment processing system to the payment acquirer in the native currency denomination of the merchant, and transmitted from the payment acquirer to the payment processing system is the customer payment for the purchased goods/services, in the native currency denomination of the customer. The payment acquirer then transmits to a bank account designated by the merchant, the received settlement amount in the native currency denomination of the merchant.

### BRIEF DESCRIPTION OF THE DRAWINGS

The accompanying appendices and/or drawings illustrate various non-limiting example, inventive aspects in accordance with the present disclosure:

FIG. 1 illustrates an example communication network used with one or more of the illustrated embodiments described herein;

FIG. 2 illustrates an example network device/node preferably used with the FXC Module and other illustrated embodiments described herein; and

FIGS. 3 and 4 illustrate system and flow level diagrams depicting one or more illustrated embodiments of an FXC Module.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (“LANs”) to wide area networks (“WANs”). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (“SONET”), synchronous digital hierarchy (“SDH”) links, or Powerline Communications (“PLC”), and others.

FIG. 1 is a schematic block diagram of an example communication network 100 illustratively comprising nodes/devices 101-108 (e.g., FXC Module 103, smart phone devices 105, web servers 106, routers 103, 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or “Flash memory”), an optical fiber, a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 2 is a schematic block diagram of an example network computing device 200 (e.g., FXC Module 103, server 106, etc.) that may be used (or components thereof) with one or more embodiments described herein, e.g., as one of the nodes shown in the network 100 of FIG. 1. As explained above, in different embodiments these various devices are configured to communicate with each other in any suitable way, such as, for example, via communication network 100.

Device 200 is intended to represent any type of computer system capable of carrying out the teachings of various embodiments of the present invention. Device 200 is only one example of a suitable system and is not intended to suggest any limitation as to the scope of use or functionality of embodiments of the invention described herein. Regardless, computing device 200 is capable of being implemented and/or performing any of the functionality set forth herein.

Computing device 200 is operational with numerous special purpose computing system environments or configurations. Examples of special purpose computing and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a special purpose computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (“MCA”) bus, Enhanced ISA (“EISA”) bus, Video Electronics Standards Association (“VESA”) local bus, and Peripheral Component Interconnect (“PCI”) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as RAM 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a LAN or WAN, and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With the exemplary communication network 100 (FIG. 1) and computing device 200 (FIG. 2) being generally shown and discussed above, description of certain illustrated embodiments of the present invention will now be provided. With reference now to FIG. 3, illustrated is a system level diagram in accordance with an illustrated embodiment depicting implementation of the FXC module 103 in a payment processing system 300 for an online merchant 302, and as also shown in FIG. 4 with reference to process 400. It is to be understood that in accordance with the operational steps shown in FIGS. 3 and 4, demonstrating implementation of the various exemplary embodiments, it is to be appreciated that the order of steps shown in FIGS. 3 and 4 are not always required, so in principle, the various steps may be performed out of the illustrated order. Also certain steps may be skipped, different steps may be added or substituted, or selected steps or groups of steps may be performed in a separate application following the embodiments described herein.

It is to be appreciated that in accordance with the FXC Module 103 depicted in FIG. 3, and in accordance with the descriptions provided the illustrated embodiments depicted in FIGS. 3 and 4, for a merchant 302 utilizing the FXC Module 103, obviated is the requirement for moving exchange rates or maintaining a complex database of payment currencies. The merchant merely prices goods/services as routine, in their native local currency (e.g., GBP). When a customer 304 visits the merchant's website 302, prices are displayed in the customer's (“cardholder's”) local currency (e.g., USD). A plurality of different currencies may be displayed while settlement to the merchant's 302 bank account is preferably accomplished in the merchant's local currency (e.g., GBP or any electronically traded currency). The merchant 302 receives the exact amount of the transaction specified in the merchant's local currency (e.g., GBP) in a designated bank account of the merchant, less an acquiring fixed fee (e.g., 1%) associated with the FXC Module 103. Thus when a customer 304 makes a payment, they do so in their own local currency (e.g., USD), and the amount shown is exactly what they will pay, saving the cardholder customer 304 additional fees for conversion and/or non-domestic card use unless the issuing bank charges such additional fees as a matter of policy. Thus the FXC Module 103 of the illustrated embodiment provides business flexibility for the merchant 302 by allowing it to decide how often prices are updated, which can be altered on any periodic basis (e.g., annually, daily, hourly, etc.). The FXC Module 103 is preferably configured to transmit, upon request, currency rates to the online merchant 302, preferably providing updated pricing within seconds if desired. The FXC Module 302 preferably accommodates a plurality of different currencies, including, but not limited to: USD, EUR, CAD, GBP, SEK, DKK, NOK, CHF, HKD, SGD, JPY, AUD, NZD, ZAR, PLN, HUF & CZK.

The load balancing functionality provided by FXC Module 103 enables merchants 302 having a requirement in more than one currency to effectively manage all of their currency needs. For example, a merchant has bills of USD 100, yet sales of USD 1,000, and with a reporting currency of CAD, the merchant can set the load balancer to collect the first USD 100 in sales in USD, then convert the remaining USD into CAD automatically. It is to be appreciated that merchants 302 utilizing the FXC Module 103 do not have to move exchange rates and/or maintain a complex database of payment currencies. The merchant 302 merely prices their goods/services in routine practice, in their local currency such that when a customer 304 visits a merchant's website 302, prices are displayed in the customer cardholders 304 local native currency. Hence customers 304 have the ability to pay using one of a plurality or range of different currency denominations while settlement to a bank account associated with the merchant 302 is accomplished in the merchant's local currency.

With continuing reference to FIGS. 3 and 4, it is to be understood integrating a gateway of the FXC Module 103 can be preferably accomplished in an efficient manner. The gateway of the FXC Module 103 when integrated to an e-commerce merchant's hosted website payment page provides a virtual online terminal for both mail and telephone based transactions. It further preferably includes a comprehensive back office solution for reporting and finance management for the online merchant 304. The gateway of the FXC Module 103 is preferably integrated with a plurality of payment gateways and payment acquiring banks.

With regards to the service provided by the FXC Module 103, it is to be appreciated an online merchant 302 preferably utilizes a merchant account supplied by its payment acquirer to process online transactions received from online customers 304. It is to be appreciated that when a common domestic currency transaction (e.g., GBP) is processed between the merchant 302 and a customer 304 (steps 310-314), the FXC Module 103 is preferably not involved in such a payment process. For instance, in step 310 a transaction between the customer 304 and merchant is processed in GBP currency via a merchant account. A payment acquirer first collects processing fees from this transaction and then provides a settlement amount to the merchant (step 312), after which the transaction is accomplished between the merchant 302 and the customer 304 (step 314).

Thus, it is to be appreciated and understood that the FXC Module 103 is preferably only engaged when a difference of currency exists between the merchant 302 and a customer 304. With reference now to steps 316-3xx of FIG. 3, the process for conducting a transaction when there is a difference of currency between a merchant 302 (e.g., EUR) and a customer 304 (e.g., (GBP) will now be described in accordance with the illustrated embodiment. For instance, when a German hotel merchant 302 having a local EUR currency sells room bookings from its website (e.g., €135.00) and a Dutch citizen customer 304 having a local EUR currency books a room, the prices on the merchant's website are displayed in Euros on the website (e.g., €135.00), and the transaction is processed via their payment acquirer as normal, without engagement by the FXC Module 103 in accordance with aforesaid steps 310-314.

However, when a UK citizen customer (GBP) visits the German merchant's website 392 to book a hotel room selling in the currency denomination of the merchant 302 (e.g., €135.00), the website is operable and configured to recognize the customer is a UK citizen (e.g., via inspection of the customer's IP address) such that pricing is displayed in GBP (e.g., £99.00). The FXC Module 103 is thus engaged whereby when the UK customer 304 chooses to pay the price displayed in GBP (e.g., £99.00), the transaction is then directed to the FXC Module 103, preferably via the relevant integration method (step 316). An instruction is preferably caused to be transmitted to one of the FXC's 103 designated FX partners (step 318) to obtain a rate for converting the currency from EUR (€) to GBP (£). It is to be understood the online merchant's 302 price list is preferably maintained in the customer's currency denomination and needs to display the customer's denomination (e.g., GBP(£)) price to the customer 304 (e.g., £99.00). The obtained rate is then used to convert the customer's currency denomination (e.g., GBP(£)) to the merchant's currency denomination (e.g., EUR(€)) currency to ensure that the merchant 302 receives currency in the merchant's currency denomination (e.g., EUR(€)), preferably into a designated bank account associated with the merchant 302.

It is noted the aforesaid payment acquirer processes the card payment in the currency denomination of the customer 304 (e.g., GBP(£)), takes its associated fee(s) from this card payment (e.g., £99.00), preferably in the currency denomination of the customer (e.g., GBP(£)) (step 320). Next, the nominated FX provider sends the settlement amount (e.g., £132.30), in the currency denomination of the merchant 304 (e.g., EUR), minus a designated fee (e.g., 1%) to the aforesaid payment acquirer (step 322). The payment acquirer then receives this settlement amount from the FX provider (e.g., £132.30), in the currency denomination of the merchant 304 (step 324). Next, the payment acquirer pays the net amount received from the customer 304, in the customer's currency denomination (e.g., £99.00), to the FX provider (step 326). Afterwards, the payment acquirer pays the received settlement amount from the FX provider (step 322)(e.g., £132.30), in the currency denomination of the merchant 302, to the merchant 302 (step 330) so as to complete the transaction between the merchant 302 and the customer 304 (step 332). Also, returning to step 326, the FX provider receives the net amount received from the customer 304, in the customer's currency denomination (e.g., £99.00) (step 328) such that the balance of the aforesaid transaction is booked in the FX account (step 334).

It is to be appreciated that the FXC Module 103 is configurable and operable such that an online merchant 302 can offer a customer 304 a choice of currency, or can be set to automatically change the displayed currency reflective of the determined geographic location of the customer 304. Additionally, the FXC Module 103 is configurable and operable such that a customer 304 may be queried to select their native currency on first (or subsequent) visit to a merchant's website, or alternatively, the merchant's website may be operable to automatically determine the customer's 304 geographic location (e.g., detecting an IP address location) to automatically display prices in the currency associated with the determined customer's 304 geographic location. Thus, the FXC Module 103, via the merchant website (302) may provide a customer 304 with the ability to change currency as desired. Hence, it is to be appreciated the FXC Module 103 is configured and operable to display merchant prices in the customer cardholders native currency, preferably based on their IP address or physical location, in contrast to the card account currency, whereby the cardholder is provided with the ability to override the currency manually if required.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof. Certain advantages of the FXC Module 103 in accordance with the illustrated embodiments include (but are not limited to) enabling merchants 304 to efficiently market goods and services globally by enabling customers 304 to pay in an associated currency denomination. Foreign currency exposure is eliminated for customers 304 of a merchant 302 while also eliminating the hardships of administrating multiple currency accounts imposed upon a merchant. The FXC Module 103 also facilitates an effective reduction of international acquiring fees, preferably to a designated rate (e.g., 1%) reflective of the value of the transaction.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer system for processing electronic card, crypto and other forms of payments between a merchant and customer for goods/services, comprising:
a memory configured to store instructions;
a processor disposed in communication with said memory, wherein said processor upon execution of the instructions is configured to:
determine if a native currency of the merchant matches with a native currency of the customer;
determine the price of the merchants' goods/services in the native currency of the customer if no match was determined between the native currency of the merchant matches and the native currency of the customer;
enable the merchant to display the price of the merchants' goods/services to the customer in the native currency of the customer;
enable the customer to purchase the merchants' goods/services using the customers native currency whereby the price displayed to the customer is the actual price paid by the customer for the merchants' goods/services; and
cause the proceeds of the sale from the customer for the purchased merchants' goods/services to be converted from the native currency of the customer to the native currency of the merchant whereby the proceeds are converted to the merchants' requested or native currency.

2. The computer system as recited in claim 1, wherein the processor is further configured to cause to be deposited the currency converted proceeds of the sale from the customer for the purchased merchants' goods/services in a bank account associated with the merchant.

3. The computer system as recited in claim 1, wherein enabling the merchant to display the price of the merchants' goods/services to the customer in the native currency of the customer utilizes current exchange rates between the native currency rates of the customer and merchant.

4. The computer system as recited in claim 1, wherein the processor is further configured to determine the native currency denomination of the customer.

5. The computer system as recited in claim 4, wherein an IP address of the customer is utilized to determine the native currency denomination of the customer.

6. The computer system as recited in claim 1, wherein the processor is further configured to provide a listing of plurality of native currency denominations to be selected for use by the customer.

7. A computer system for processing payments between a merchant and customer for goods/services using a payment processing system, comprising:
a memory configured to store instructions;
a processor disposed in communication with said memory, wherein said processor upon execution of the instructions is configured to:
determine if a native currency of the merchant matches with a native currency of the customer;
determine the price of the merchants' goods/services, using the payment processing, in the native currency of the customer if no match was determined between the native currency of the merchant matches and the native currency of the customer;
enable the customer to purchase the merchants' goods/services, by a payment acquirer associated with the merchant, using the customers native currency whereby the price displayed to the customer is the actual price paid by the customer for the merchants' goods/services;
transmit a settlement amount for the price of the purchased goods/services from the payment processing system to the payment acquirer in the native currency denomination of the merchant;
transmit, from the payment acquirer to the payment processing system, the customer payment for the purchased goods/services, in the native currency denomination of the customer; and
transmit, from the payment acquirer to a bank account designated by the merchant, the received settlement amount in the native currency denomination of the merchant.

8. The computer system as recited in claim 7, wherein the processor is further configured to determine the native currency denomination of the customer.

9. The computer system as recited in claim 8, wherein an IP address of the customer is utilized to determine the native currency denomination of the customer.

10. The computer system as recited in claim 1, wherein the processor is further configured to provide a listing of plurality of native currency denominations to be selected for use by the customer.

11. A computer method for processing payments between a merchant and customer for goods/services using a payment processing system, comprising:
determining if a native currency of the merchant matches with a native currency of the customer;
determining the price of the merchants' goods/services, using the payment processing, in the native currency of the customer if no match was determined between the native currency of the merchant matches and the native currency of the customer; p1 enabling the customer to purchase the merchants' goods/services, by a payment acquirer associated with the merchant, using the customers native currency whereby the price displayed to the customer is the actual price paid by the customer for the merchants' goods/services;
transmitting a settlement amount for the price of the purchased goods/services from the payment processing system to the payment acquirer in the native currency denomination of the merchant;
transmitting, from the payment acquirer to the payment processing system, the customer payment for the purchased goods/services, in the native currency denomination of the customer; and
transmitting, from the payment acquirer to a bank account designated by the merchant, the received settlement amount in the native currency denomination of the merchant.

12. The computer method as recited in claim 11, further including determining the native currency denomination of the customer.

13. The computer method as recited in claim 12, wherein an IP address of the customer is utilized to determine the native currency denomination of the customer.

14. The computer method as recited in claim 1, further including providing a listing of plurality of native currency denominations to be selected for use by the customer.
